(19) United States
(12) Patent Application Publication
(10) Pub. No.: US 2014/0192552 A1
(43) Pub. Date: Jul. 10, 2014

(54) BACKLIGHT MODULE

(71) Applicant: Shenzhen China Star Optoelectronics Technology Co. Ltd., Shezhen, Guangdong (CN)

(72) Inventor: Hu He, Shenzhen City (CN)

(73) Assignee: Shenzhen China Star Optoelectronics Technology Co., Ltd., Shenzhen, Guangdong (CN)

(21) Appl. No.: 13/817,745

(22) PCT Filed: Jan. 14, 2013
(86) PCT No.: PCT/CN13/70428

§ 371 Date: Feb. 19, 2013

(30) Foreign Application Priority Data
Jan. 6, 2013 (CN) 201310003380.X

(51) Int. Cl. F21V 8/00

(52) U.S. Cl. CPC G02B 6/0028
USPC 362/603

(57) ABSTRACT

The present invention provides a backlight module which contains a collection device for collecting sunlight, an optical fiber cable, at least a light guide device connecting the collection device through the optical fiber cable, and a diffusion device and an optical member fixed at a distance from a side of each light guide device. Sunlight is collected by the collection device and is introduced into each light guide device; and each light guide device then guides and projects the collected sunlight onto the diffusion device and the optical member sequentially. The energy consumption and environmental friendliness of the backlight module of the present invention are greatly enhanced. The illumination efficiency and lighting uniformity are also improved by a simplified structure.

This application claims the benefit of People's Republic of China patent application No. 201310003380.X, filed Jan. 6, 2013, which application is incorporated by reference herein in its entirety.

### BACKGROUND OF THE INVENTION

1. Field of the Invention

The present invention generally relates to liquid crystal display technique, and particularly relates to a backlight module.

2. The Related Arts

A liquid crystal display (LCD) device contains a display module for presenting images and a backlight module for illumination. Currently most LCD backlight modules employ light emitting diodes (LEDs) as light source due to their high efficiency and energy saving.

To achieve further energy saving, the number of LEDs employed in a LCD backlight module has to be reduced. However, this reduction could affect the backlight module's quality to a certain degree.

As such, how to reduce the LEDs as many as possible without sacrificing the backlight module's quality is a major challenge to the existing backlight module design.

### SUMMARY OF THE INVENTION

The technical issue to be addressed by the present invention is to provide a backlight module to greatly reduce energy consumption and to achieve better environmental friendliness while improving illumination efficiency and lighting uniformity with a simplified structure.

To address the technical issue, the present invention provides a backlight module, containing a collection device for collecting sunlight, an optical fiber cable, at least a light guide device connecting the collection device through the optical fiber cable, and a diffusion device and an optical member fixed at a distance from a side of each light guide device. The sunlight is collected by the collection device and is introduced into each light guide device. Each light guide device then guides and projects the collected sunlight onto the diffusion device and the optical member sequentially. Each light guide device has an incident end and a distant end. The optical fiber cable has one end connected to the collection device and the other end connected to the incident end of each light guide device. The collected sunlight travels along each light guide device from the incident end towards the distant end.

Alternatively, a reflection piece is attached to the distant end of each light guide device to reflect light not guided out by the light guide device.

Alternatively, there are at least two light guide devices, each pair of adjacent light guide devices has a specific distance in between, and the incident ends of the light guide devices are positioned at a same side of the backlight module.

Alternatively, each light guide device is a light guide strip.

Alternatively, each light guide device has a flat top side, or has prism structure on the top side.

Alternatively, the diffusion device is a diffusion plate, and the optical member is an optical film.

To address the technical issue, the present invention further provides a backlight module, containing a collection device for collecting sunlight, an optical fiber cable, at least a light guide device connecting the collection device through the optical fiber cable, and a diffusion device and an optical member fixed at a distance from a side of each light guide device. Sunlight is collected by the collection device and is introduced into each light guide device. Each light guide device then guides and projects the collected sunlight onto the diffusion device and the optical member sequentially. Each light guide device has both ends as incident ends. The optical fiber cable has one end connected to the collection device and the other end connected to the incident ends of each light guide device.

Alternatively, there are at least two light guide devices, and each pair of adjacent light guide devices has a specific distance in between.

To address the technical issue, the present invention further provides a backlight module, containing a collection device for collecting sunlight, an optical fiber cable, at least a light guide device connecting the collection device through the optical fiber cable, and a diffusion device and an optical member fixed at a distance from a side of each light guide device. Sunlight is collected by the collection device and is introduced into each light guide device. Each light guide device then guides and projects the collected sunlight onto the diffusion device and the optical member sequentially.

Alternatively, a number of grid dots are configured along a bottom side of each light guide device, and the collected sunlight is guided out of each light guide device by the grid dots.

Alternatively, the grid dots are outwardly bulged or inwardly indented structures.

Alternatively, the grid dots are uniformly arranged along the bottom side of each light guide device by printing or injection molding, and the backlight module further contains a reflection device positioned beneath the grid dots of each light guide device.

Alternatively, each light guide device has an incident end and a distant end, the optical fiber cable has one end connected to the collection device and the other end connected to the incident end of each light guide device, and the collected sunlight travels along each light guide device from the incident end towards the distant end.

Alternatively, a reflection piece is attached to the distant end of each light guide device to reflect light not guided out by the light guide device.

Alternatively, there are at least two light guide devices; each pair of adjacent light guide devices has a specific distance in between; and the incident ends of the light guide devices are positioned at a same side of the backlight module.

Alternatively, each light guide device has both ends as incident ends, and the optical fiber cable has one end connected to the collection device and the other end connected to the incident ends of each light guide device.

Alternatively, there are at least two light guide devices; and each pair of adjacent light guide devices has a specific distance in between.

Alternatively, each light guide device is a light guide strip.

Alternatively, each light guide device has a flat top side, or has prism structure on the top side.

Alternatively, the diffusion device is a diffusion plate; and the optical member is an optical film.

The advantage of the present invention is as follows. The sunlight collected by the collection device is introduced into one or more light guide devices through optical fiber cable, the light guide devices then guide and project the collected sunlight sequentially on the diffusion device and optical member so as to achieve uniform backlight illumination. The backlight module of the present invention uses sunlight as an independent light source to replace LEDs. The energy consumption and environmental friendliness are therefore greatly enhanced. The light guide devices function just like light guide plate to project sunlight onto optical film, thereby achieving better illumination efficiency. In addition, as grid dots are configured on the light guide devices, the uniformity of illumination is improved.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a cross-sectional diagram showing a backlight module according to an embodiment of the present invention;

FIG. 2 is a perspective diagram showing the backlight module of FIG. 1;

FIG. 3 is a sectional diagram showing a light guide device according to a first embodiment of the present invention;

FIG. 4 is a sectional diagram showing a light guide device according to a second embodiment of the present invention;

FIG. 5 is a sectional diagram showing a light guide device according to a third embodiment of the present invention;

FIG. 6 is a sectional diagram showing a light guide device according to a fourth embodiment of the present invention; and

FIG. 7 is a perspective diagram showing a backlight module according to another embodiment of the present invention.

### DETAILED DESCRIPTION OF THE PREFERRED EMBODIMENTS

Together with the accompanied drawings, detailed description to the embodiments of the present invention is provided as follows

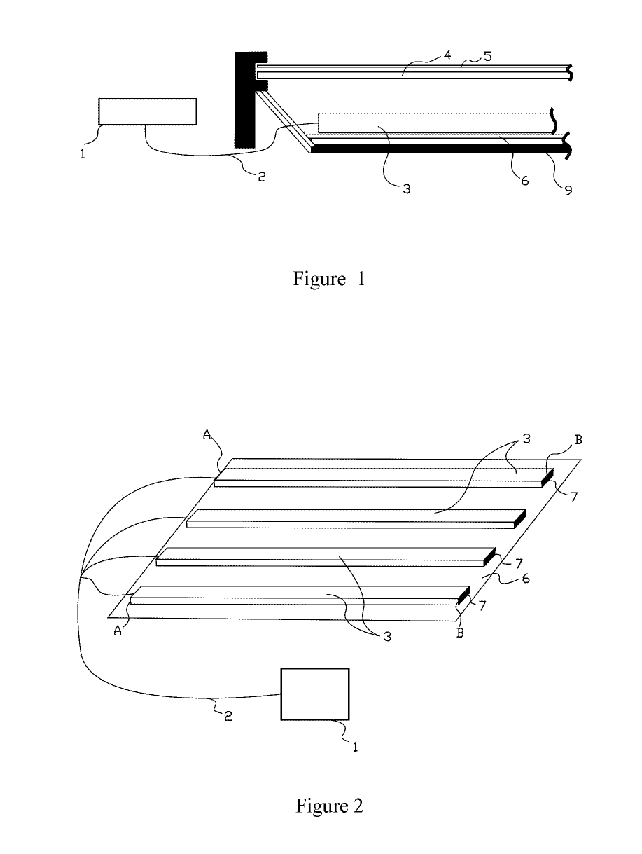

FIGS. 1 and 2 depict a backlight module according to an embodiment of the present invention.

In a cross-sectional diagram of the present embodiment as illustrated in FIG. 1, the backlight module contains a collection device 1 for collecting sunlight, an optical fiber cable 2, a light guide device 3 connected to the collection device 1 through the optical fiber cable 2, a diffusion device 4 and an optical member 5, both positioned to a side of and at a distance from the light guide device 3.

The optical fiber cable 2 transmits the sunlight collected by the collection device 1 to the light guide device 3. The light guide device 3 then transmits and projects the collected sunlight towards the diffusion device 4 and the optical member 5 sequentially.

The collection device 1, in alternative embodiments, can be replaced by, for example, a sunlight collection device, a sunlight collection system, etc. The major function of the collection device 1 is to collect the clean and regenerative solar energy.

The optical fiber cable 2 connecting the collection device 1 and the light guide device 3 can contain a single fiber or fiber bundle in various embodiments. Its function is to guide the sunlight collected by the collection device 1 into the light guide device 3.

In the present embodiment, there are multiple light guide devices 3 and, correspondingly, each light guide device 3 is connected to an end of a fiber or a fiber bundle of the optical fiber cable 2. The other ends of the fibers or fiber bundles are connected to the collection device 1.

The function of each light guide device 3 is to guide the collected sunlight from the optical fiber cable 2 and, through the diffusion device 4 and the optical member 5, to form uniform backlight.

In a perspective diagram of the present embodiment as illustrated in FIG. 2, the light guide devices 3 are embodied as four rectangular light guide strips arranged in parallel with a specific distance between adjacent pairs of light guide strips so as to enlarge the illumination coverage.

Since the arrangement of the light guide strips determines the illumination effect of the backlight module, the present embodiment has the light guide strips symmetrically aligned in parallel equally spaced apart so as to achieve uniform illumination.

Each light guide strip has an incident end A and a distant end B. As shown in FIG. 2, all incident ends A of the light guide strips are arranged to the left of FIG. 2, and each fiber (or fiber bundle) is connected the incident end A of a light guide strip, respectively. The sunlight collected by the collection device 1 is then introduced, through the optical fiber cable 2, into the incident ends A and towards the distant ends B.

Preferably, a reflection piece 7 is attached to the side of each light guide strip's distant end B so as to reflect the light not guided out by the light guide strips and as such reaching the distant ends B. The reflection pieces 7 help enhancing the utilization efficiency of the collected light.

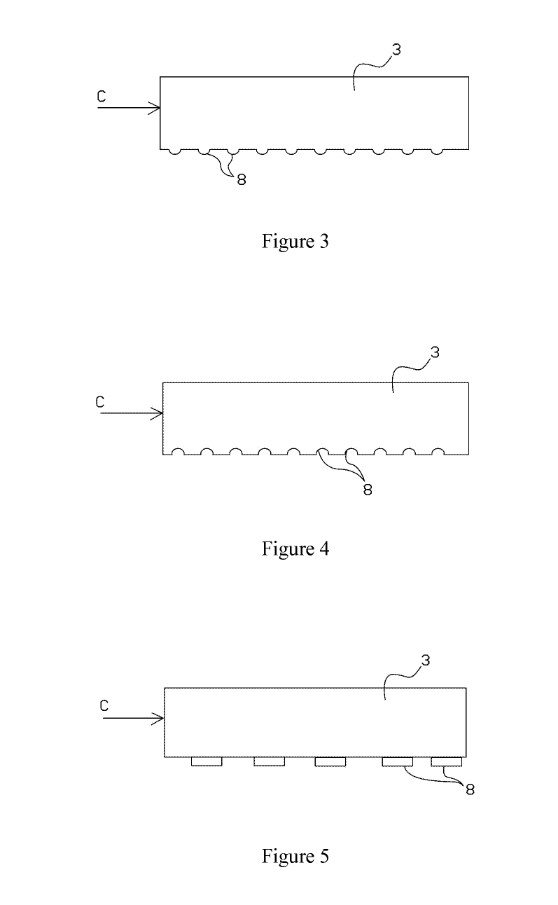

The uniform guiding of the collected light by the light guide strips is achieved by the following structures. A first embodiment of the light guide strip is illustrated in a sectional diagram in FIG. 3.

A number of grid dots 8 are configured along a bottom side of each light guide device 3. When the collected light C is introduced through the optical fiber cable 2 into a light guide device 3, and as the collected light C travels along the light guide device 3, the collected light C is reflected by the grid dots 8 and as such guided out of the light guide device 3.

In the present embodiment, each grid dot 8 bulges outward with semi-spherical cross section. The grid dots 8 can be formed by printing or injection molding.

Since the arrangement of the grid dots 8 affects the uniformity of the out-guided light, in the present embodiment, the grid dots 8 are uniformly configured on the bottom side of each light guide device 3. A reflection device 6 is fixed on a back plate 9 and is positioned beneath the grid dots 8. In the present embodiment, the reflection device 6 is the reflection plate.

Each light guide strip has a flat top side. At a distance above the flat top side of each light guide strip, the diffusion device 4 (e.g., a diffusion plate) and the optical member 5 (e.g., an optical film) are sequentially arranged. The light guided out by each light guide strip then projects on the diffusion plate 4 and the optical film 5 sequentially. As such, a uniformly illuminating backlight module is achieved.

A second embodiment of the light guide strip is illustrated in a sectional diagram in FIG. 4. In the present embodiment, each grid dot 8 bulges inward with semi-spherical cross section. The grid dots 8 are arranged uniformly. When the collected light C is introduced through the optical fiber cable 2 into a light guide device 3, and as the collected light C travels along the light guide device 3, the collected light C is reflected by the grid dots 8 and as such guided out of the light guide device 3.

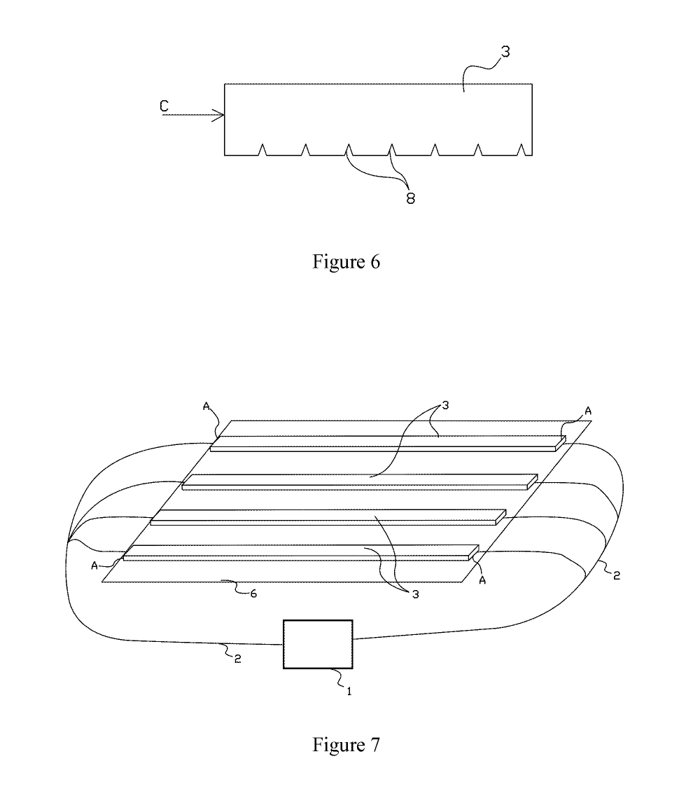

In alternative embodiments, the grid dots 8 can be embodied in various uniformly arrangements of outwardly bulged or inwardly indented structures. As illustrated in FIG. 5, the grid dots 8 are formed by printing into separate pieces. As illustrated in FIG. 6, the grid dots 8 are formed by V-cut means into inwardly indented V-shaped structures.

It should be understandable that the grid dots 8 can be arranged on other places such on the middle and lower sections of the light guide strips' lateral sides, in addition to along the bottom sides of the light guide strips, without affecting the illuminating effect. Additionally, instead of having flat top sides, the light guide strips can have prism structures arranged along the length of the light guide strips.

According to the present embodiment of the backlight module, the light guide devices 3 are actually an integral part of the backlight module, achieving even simpler structure.

FIGS. 1 and 7 depict a backlight module according to another embodiment of the present invention.

In a perspective diagram of the present embodiment as illustrated in FIG. 7, the difference between the present and the previous embodiments lies in the following. The light guide devices 3 of the previous embodiment has the collected light incident into one end whereas the light guide devices 3 of the previous embodiment has the collected light incident into both ends. In other words, both ends of each light guide device 3 are incident ends A, and the incident ends A are arranged at both left and right sides of FIG. 7. As such, the sunlight collected by the collection device 1 is introduced into all light guide strips through the optical fiber cable 2.

The present embodiment also adopts the same grid dots 8 structured as shown in FIGS. 3 to 6 for guiding light out. The details are therefore omitted here.

A backlight module according to the present invention has the following effect. The sunlight collected by the collection device is introduced into one or more light guide devices through optical fiber cable, the light guide devices then guide and project the collected sunlight sequentially on the diffusion device and optical member so as to achieve uniform backlight illumination. The backlight module of the present invention uses sunlight as an independent light source to replace LEDs. The energy consumption and environmental friendliness are therefore greatly enhanced. The light guide devices function just like light guide plate to project sunlight onto optical film, thereby achieving better illumination efficiency. In addition, as grid dots are configured on the light guide devices, the uniformity of illumination is improved.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight module, comprising:
a collection device for collecting sunlight;
an optical fiber cable;
at least a light guide device connecting the collection device through the optical fiber cable; and
a diffusion device and an optical member fixed at a distance from a side of each light guide device;
wherein sunlight is collected by the collection device and is introduced into each light guide device; each light guide device then guides and projects the collected sunlight onto the diffusion device and the optical member sequentially; each light guide device has an incident end and a distant end; the optical fiber cable has one end connected to the collection device and the other end connected to the incident end of each light guide device; and the collected sunlight travels along each light guide device from the incident end towards the distant end.

2. The backlight module as claimed in claim 1, wherein a reflection piece is attached to the distant end of each light guide device to reflect light not guided out by the light guide device.

3. The backlight module as claimed in claim 2, wherein there are at least two light guide devices; each pair of adjacent light guide devices has a specific distance in between; and the incident ends of the light guide devices are positioned at a same side of the backlight module.

4. The backlight module as claimed in claim 1, wherein each light guide device is a light guide strip.

5. The backlight module as claimed in claim 4, wherein each light guide device has a flat top side, or has prism structure on the top side.

6. The backlight module as claimed in claim 1, wherein the diffusion device is a diffusion plate; and the optical member is an optical film.

7. A backlight module, comprising:
a collection device for collecting sunlight;
an optical fiber cable;
at least a light guide device connecting the collection device through the optical fiber cable; and
a diffusion device and an optical member fixed at a distance from a side of each light guide device;
wherein sunlight is collected by the collection device and is introduced into each light guide device; each light guide device then guides and projects the collected sunlight onto the diffusion device and the optical member sequentially; each light guide device has both ends as incident ends; and the optical fiber cable has one end connected to the collection device and the other end connected to the incident ends of each light guide device.

8. The backlight module as claimed in claim 7, wherein there are at least two light guide devices; and each pair of adjacent light guide devices has a specific distance in between.

9. A backlight module, comprising:
a collection device for collecting sunlight;
an optical fiber cable;
at least a light guide device connecting the collection device through the optical fiber cable; and
a diffusion device and an optical member fixed at a distance from a side of each light guide device;
wherein sunlight is collected by the collection device and is introduced into each light guide device; and each light guide device then guides and projects the collected sunlight onto the diffusion device and the optical member sequentially.

10. The backlight module as claimed in claim 9, wherein a plurality of grid dots are configured along a bottom side of each light guide device; and the collected sunlight is guided out of each light guide device by the grid dots.

11. The backlight module as claimed in claim 10, wherein the grid dots are outwardly bulged or inwardly indented structures.

12. The backlight module as claimed in claim 11, wherein the grid dots are uniformly arranged along the bottom side of each light guide device by printing or injection molding; and the backlight module further comprises a reflection device positioned beneath the grid dots of each light guide device.

13. The backlight module as claimed in claim 12, wherein each light guide device has an incident end and a distant end; the optical fiber cable has one end connected to the collection device and the other end connected to the incident end of each light guide device; and the collected sunlight travels along each light guide device from the incident end towards the distant end.

14. The backlight module as claimed in claim 13, wherein a reflection piece is attached to the distant end of each light guide device to reflect light not guided out by the light guide device.

15. The backlight module as claimed in claim 13, wherein there are at least two light guide devices; each pair of adjacent light guide devices has a specific distance in between; and the incident ends of the light guide devices are positioned at a same side of the backlight module.

16. The backlight module as claimed in claim 12, wherein each light guide device has both ends as incident ends; and the optical fiber cable has one end connected to the collection device and the other end connected to the incident ends of each light guide device.

17. The backlight module as claimed in claim 16, wherein there are at least two light guide devices; and each pair of adjacent light guide devices has a specific distance in between.

18. The backlight module as claimed in claim 9, wherein each light guide device is a light guide strip.

19. The backlight module as claimed in claim 18, wherein each light guide device has a flat top side, or has prism structure on the top side.

20. The backlight module as claimed in claim 9, wherein the diffusion device is a diffusion plate; and the optical member is an optical film.
